(19) United States
(12) Patent Application Publication
(10) Pub. No.: US 2012/0050007 A1
(43) Pub. Date: Mar. 1, 2012

(54) METHODS AND APPARATUS FOR INTERACTING WITH AN ELECTRONIC DEVICE APPLICATION BY MOVING AN OBJECT IN THE AIR OVER AN ELECTRONIC DEVICE DISPLAY

(76) Inventors: Babak Forutanpour, Carlsbad, CA (US); Brian Momeyer, San Diego, CA (US)

(21) Appl. No.: 12/862,066

(22) Filed: Aug. 24, 2010

(51) Int. Cl. G06F 7/04; G06F 3/033; G06F 3/044; G09G 5/00

(52) U.S. Cl. 340/5.8; 345/156; 345/179; 345/174

(57) ABSTRACT

In a first aspect, a first method is provided of interacting with an electronic device. The first method includes the steps of (1) tracking the x, y and z coordinates of an object moving above a display of the electronic device, wherein a top surface of the display is substantially aligned with an xy-plane; (2) generating an interrupt including the x, y and z coordinates; and (3) employing the tracked z coordinates of the moving object by an application of the electronic device. Numerous other aspects are provided.

### FIELD OF THE INVENTION

The present invention relates generally to electronic devices, and more particularly to methods and apparatus for interacting with an electronic device application by moving an object in the air over an electronic device display.

### BACKGROUND

Conventional electronic devices with touch screens enable a user to enter data using two dimensions. However, interacting with such a conventional device is not efficient. For example, the electronic device may require a user to press numerous keys on the touch screen just to enter a single character. Accordingly, improved methods and apparatus for interacting with an electronic device are desired.

### SUMMARY OF THE INVENTION

To overcome the disadvantages of the prior art, in one or more aspects of the present invention, methods and apparatus for interacting with an electronic device are provided. For example, in a first aspect, a first method is provided for interacting with an electronic device. The first method includes the step of (1) tracking the x, y and z coordinates of an object moving above a display of the electronic device, wherein a top surface of the display is substantially aligned with an xy-plane; (2) generating an interrupt including the x, y and z coordinates; and (3) employing the tracked z coordinates of the moving object by an application of the electronic device.

In a second aspect, a first electronic device is provided. The first electronic device includes (1) a circuit configured to track the x, y and z coordinates of an object moving above a display of the electronic device, wherein a top surface of the display is substantially aligned with an xy-plane; (2) a controller coupled to the circuit and configured to generate an interrupt including the x, y and z coordinates; and (3) a processor coupled to controller and configured to employ the tracked z coordinates of the moving object for an application executed by the processor. Numerous other aspects are provided, as are systems and computer-readable media in accordance with these and other aspects of the invention.

Other features and aspects of the present invention will become more fully apparent from the following detailed description, the appended claims and the accompanying drawings.

### BRIEF DESCRIPTION OF DRAWINGS

FIG. 1 is a block diagram of a first exemplary apparatus for interacting with an electronic device provided in accordance with an aspect.

FIG. 2 is a block diagram of a second exemplary apparatus for interacting with an electronic device provided in accordance with an aspect.

FIG. 3 is a block diagram of a third exemplary apparatus for interacting with an electronic device provided in accordance with an aspect.

FIG. 4 is a flow chart of a method of interacting with an electronic device provided in accordance with an aspect.

FIG. 5 is a side view of a display of an electronic device used for a data entry application in accordance with an aspect.

FIGS. 6A-C illustrate a display of an electronic device used for an authentication application in accordance with an aspect.

### DETAILED DESCRIPTION

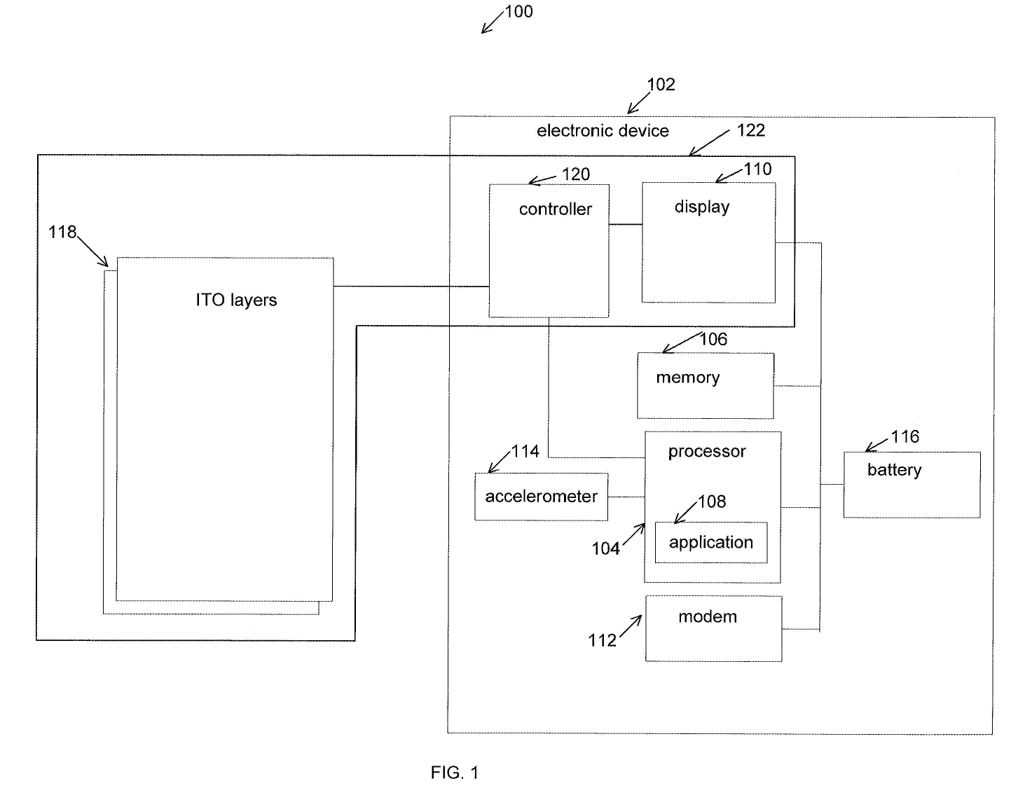

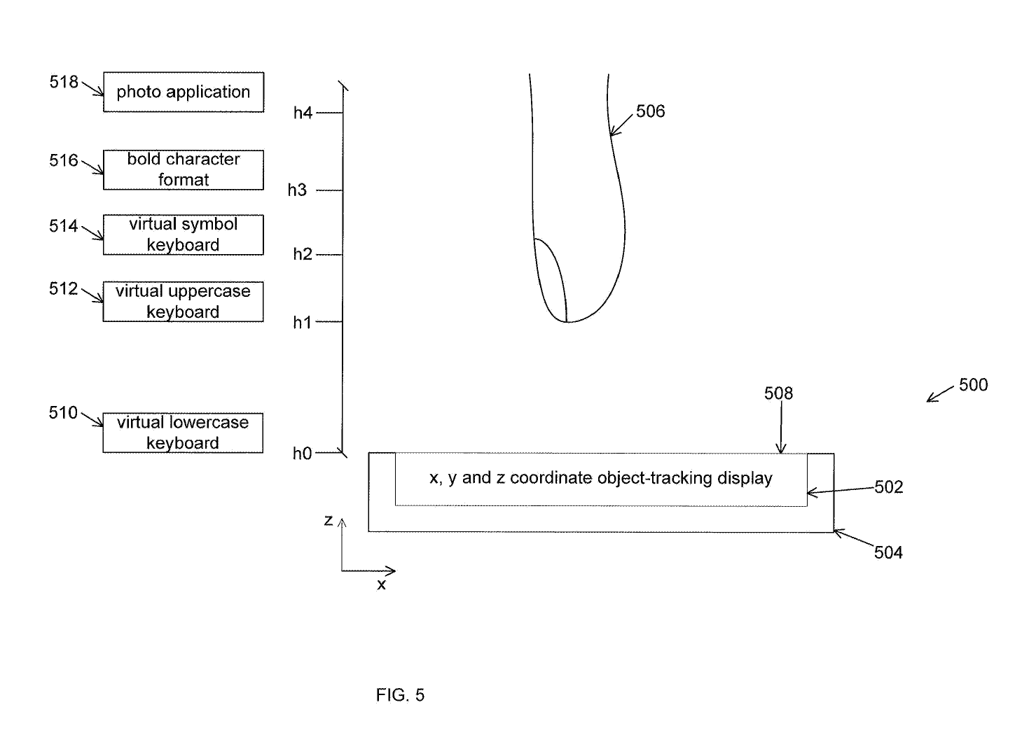

FIG. 1 is a block diagram of a first exemplary apparatus for interacting with an electronic device provided in accordance with an aspect. The first exemplary apparatus 100 may be an electronic device 102, such as a cellular phone, a personal digital assistant (PDA), a laptop computer, user device, smartphone, automated teller machine, etc. The electronic device 102 may include a processor 104 coupled to a memory 106. The processor 104 may be adapted to store and execute code (e.g., one or more applications 108). The memory 106 may store program codes and data. Further, the electronic device 102 may include a display 110 for presenting data to a user of the electronic device 102. The display may be an LCD or any other similar device that may be employed by an electronic device to present data to a user. The electronic device 102 may include a modem 112 adapted to provide network connectivity to the electronic device 102. The electronic device 102 may also include an accelerometer 114 or similar device coupled to the processor 104 and adapted to detect movement (e.g., a shaking of the electronic device 102). The electronic device 102 may include a battery 116 that serves as a power source for components coupled to the electronic device 102. The display 110 of the electronic device 102 may be coupled (e.g., operatively coupled) to a plurality of Indium Tin Oxide (ITO) layers (e.g., dual ITO layers) 118 via a controller 120 thereby forming a touch screen 122. However, layers including additional or different materials may be employed. The touch screen 122 may be a capacitive or resistive touch screen. Although other types of touch screens may be employed. The plurality of ITO layers 118 may be adapted to detect or compute the presence and/or position (e.g., x, y and z coordinates) of an object (not shown in FIG. 1; 506 in FIG. 5), such as a stylus, finger or the like above the display 110. Upon approach, for example, such object 506 may serve as a dielectric (e.g., ground source) for the capacitive or resistive touch screen 122. Therefore, the touch screen 122 may track movement (e.g., x, y and/or z coordinates over time) of the object 506 on (e.g., by compressing the ITO layers against the display) or in the air over the display 110. The controller 120, for example, may receive data associated with object movement from the plurality of ITO layers 118 and may generate one or more interrupts. An interrupt may include x, y and/or z coordinates associated with one or more positions of the object 506. Such interrupts may be provided to the processor 104, which may report the interrupt to an appropriate application of the one or more applications 108 executed by the processor 104. The interrupt may serve as a programming event for the application 108. In this manner, movement of the object 506 on and/or in the air over the display 110 may be used to interact with the electronic device 102 (e.g., one or more applications 108 of the electronic device 102). For example, a user may hover an object 506 over a screen which implements hover technology (e.g., the touch screen 122) to select a feature of a user interface for an application 108.

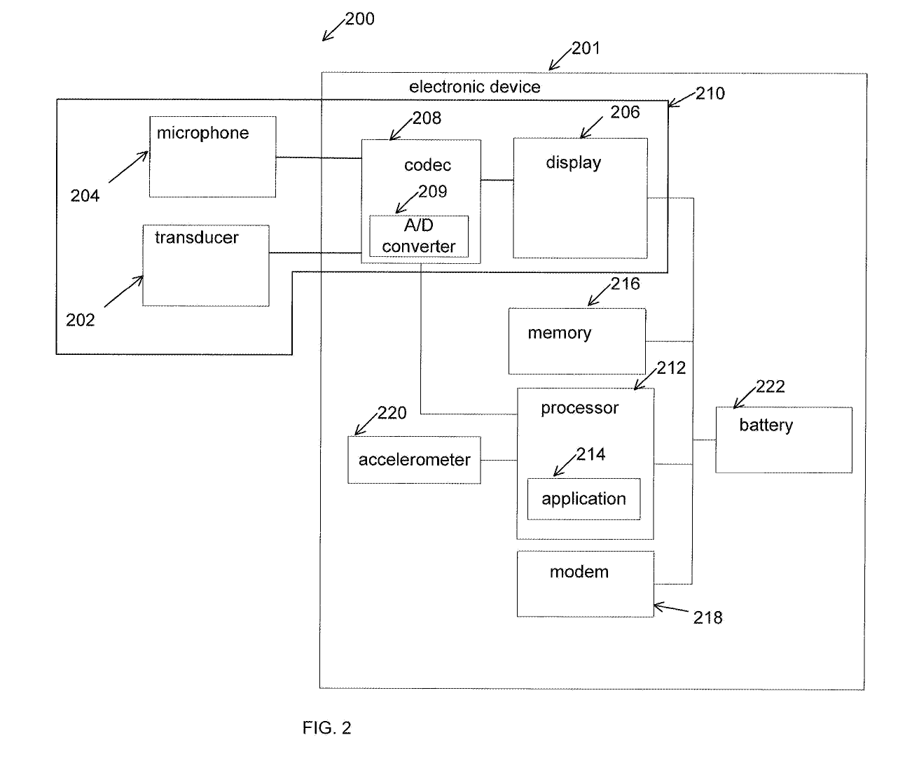

FIG. 2 is a block diagram of a second exemplary apparatus for interacting with an electronic device. The second exemplary apparatus 200 includes an electronic device 201 and is similar to the first exemplary apparatus 100. However, rather than the ITO layers 118 of a capacitive or resistive touch screen, the second exemplary apparatus 200 may include one or more transducers (e.g., speakers) 202 and one or more microphones 204 coupled to a display 206 via coding/decoding (codec) logic 208 to form a touch screen 210. The one or more transducers 202 and one or more microphones 204 may be adapted to detect or compute the presence and/or position (e.g., x, y and z coordinates) of an object an object 506 such as a stylus, finger or the like above the display 206. For example, the one or more transducers 202 may emit sound waves (e.g., ultrasonic sound waves) and the one or more microphones 204 may detect such sound waves. The presence of an object 506 above the display 206 may affect a path of the sound waves or air pressure above the display 206 such that the sound waves received by the one or more microphones 204 may indicate the presence of the object 506. Therefore, the touch screen 210 may track movement (e.g., x, y and/or z coordinates over time) of the object 506 on or in the air over the display 206. The codec logic 208, for example, may receive data associated with the moving object 506 and generate one or more interrupts. The codec logic 208 may include an analog-to-digital (ND) converter 209 to convert received data to a digital signal. Such interrupts may be provided to a processor 212 and employed by one or more applications 214 that may be stored and/or executed by the processor 212 in a manner similar to that described above for the processor 104 and application 108 of FIG. 1. Further, coupled to the processor 212, the second exemplary apparatus 200 may include a memory 216 that may store program codes and data. The second exemplary apparatus 200 may include a modem 218 adapted to provide network connectivity to the second exemplary apparatus 200. The second exemplary apparatus 200 may also include an accelerometer 220 or similar device coupled to the processor 212 and adapted to detect movement (e.g., a shaking of the second exemplary apparatus 200). The electronic device 201 may include a battery 222 that serves as a power source for the above-described components.

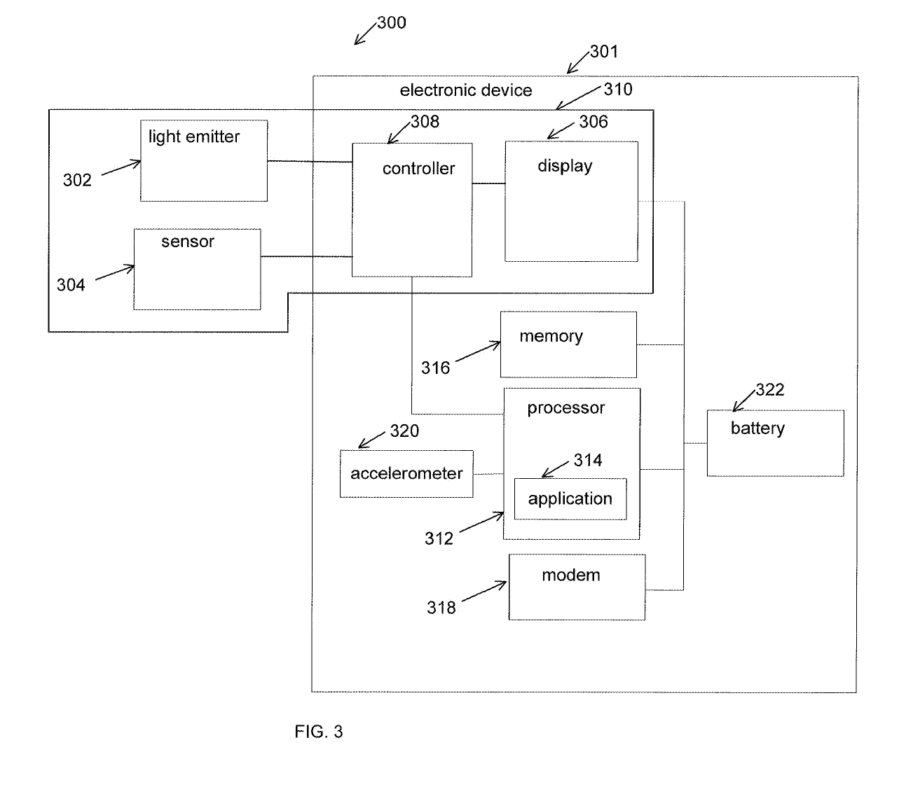

FIG. 3 is a block diagram of a third exemplary apparatus for interacting with an electronic device. The third exemplary apparatus 300 includes an electronic device 301 and is similar to the first and second exemplary apparatus 100, 200. However, rather than the ITO layers 118 of the capacitive or resistive touch screen 122 of the first exemplary apparatus 100 or the one or more transducers 202 and one or more microphones 204 of the second exemplary apparatus 200, the third exemplary apparatus 300 includes one or more light sources (e.g., infrared light emitters) 302 and one or more light sensors 304 coupled to a display 306 via a controller 308 to form a touch screen 310. The one or more light sources 302 and one or more light sensors 304 may be adapted to detect or compute the presence and/or position (e.g., x, y and z coordinates) of an object 506, such as a stylus, finger or the like above the display 306. For example, the one or more light sources 302 may emit light waves and the one or more light sensors 304 may detect light waves. The presence of an object 506 above the display 306 may affect a path of the light waves above the display 306 such that the light waves received by the one or more light sensors 304 may indicate the presence of the object 506. Therefore, the touch screen 310 may track movement (e.g., x, y and/or z coordinates over time) of the object 506 on or in the air over the display 306. The controller 308, for example, may receive data associated with the moving object 506 and generate one or more interrupts. Such interrupts may be provided to a processor 312 and employed by one or more applications 314 that may be stored and/or executed by the processor 312 in the manner described above with reference to FIGS. 1 and 2. Further, coupled to the processor 312, the third exemplary apparatus 300 may include a memory 316 that may store program codes and data. The third exemplary apparatus 300 may include a modem 318 adapted to provide network connectivity to the third exemplary apparatus 300. The third exemplary apparatus 300 may also include an accelerometer 320 or similar device coupled to the processor 312 and adapted to detect movement (e.g., a shaking of the third exemplary apparatus 300). The electronic device 301 may include a battery 322 that serves as a power source for the above-described components.

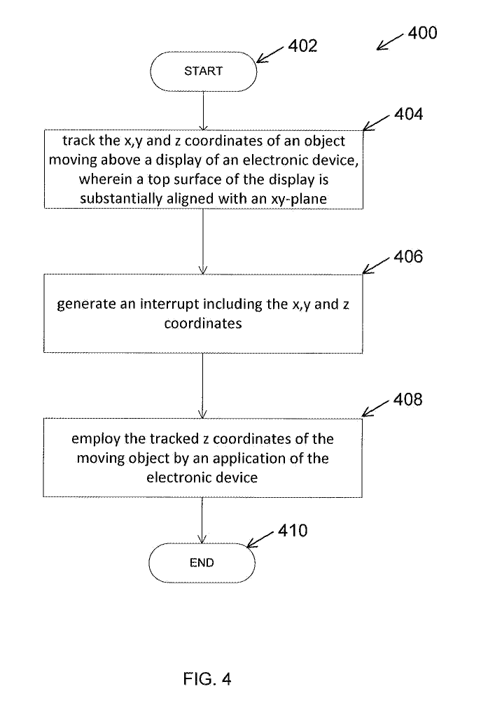

FIG. 4 is a flow chart of a method 400 of interacting with an electronic device provided in accordance with an aspect. With reference to FIG. 4, in step 402, the method 400 of interacting with an electronic device begins. In step 404, the x, y and z coordinates of an object moving above a display 108, 206, 306 of an electronic device 102, 201, 301 are tracked. A top surface (508 in FIG. 5) of the display 108, 206, 306 may be substantially aligned with an xy-plane of a coordinate system. The display 108, 206, 306 may include or be coupled to any screen technology which tracks a distance (e.g., a vertical distance) an object is away from the display 108, 206, 306 (e.g., a top surface 508 of the display 108, 206, 306) of the electronic device 102, 201, 301, such as ITO layers 118 coupled to a controller 118, one or more transducers 202 and one or more microphones 204 coupled to codec logic 208, and/or one or more light sources 302 and one or more light sensor 304 coupled to a controller 308. The object 506 may be a stylus, finger or anything that allows a user to interact with the electronic device 102, 201, 301, for example, by allowing the user to select features from a user interface of an application 108, 214, 314 executed by the electronic device 102, 201, 301. The object 506 may or may not touch the top surface 508 of the display 108, 206, 306 while the user is interacting with the electronic device 102, 201, 301. For example, the object 506 moving above the display 108, 206, 306 may touch the top surface 508 of the display 108, 206, 306 during one portion of the movement and move in the air over the display 108, 206, 306 during another portion of the movement.

In step 406, an interrupt including the x, y and z coordinates of the object 506 may be generated. For example, when a user is interacting with a data entry application of the electronic device 102, 201, 301, an interrupt may be generated when a z coordinate of the tracked object 506 has a predetermined value or is in a predetermined range of values. In this manner, a first interrupt may be generated when the object 506 is moved to a first height on or in the air over the display 108, 206, 306, a second interrupt may be generated when the object 506 is moved to a second height on or in the air over the display 102, 201, 301. In some embodiments, the electronic device 102, 201, 301 (e.g., a component of the electronic device 102, 201, 301) may generate an interrupt when one coordinate (e.g., the z coordinate) of the tracked object 506 does not change for a predetermined time period, such as 1 second. However, a larger or smaller time period may be employed. Alternatively, the electronic device 102, 201, 301 (e.g., a component of the electronic device 102, 201, 301) may generate an interrupt when more than one coordinate of the tracked object 506 does not change for a predetermined time period. For example, such interrupt may be generated when movement of the object 506 is stopped. In some embodiments, the electronic device 102, 201, 301 may generate an interrupt including x, y and z coordinates of the object 506 in response to a unique audible sound generated after the user has moved the object 506 to a desired location on or in the air over the display 108, 206, 306. The unique audible sound may be a finger snap, toe tap, mouth click, spoken word or the like. In some embodiments, an interrupt including x, y and z coordinates of the object 506 may be generated in response to a user depressing a button on the electronic device 102, 201, 301, gesturing with the object 506 (e.g., shaking or wiggling the object in the desired location above the display 102, 201, 301), or a user shaking the electronic device 102, 201, 301. Interrupts may be generated in a similar manner when the user is interacting with another application (e.g., an authentication application) 108, 214, 314 of the electronic device 102, 201, 301.

In addition to an interrupt generated based on and including x, y, and z coordinates of the object 506, in some embodiments, an interrupt may be generated in response to a unique audible sound, a user depressing a button, gesturing with the object and/or a user shaking the electronic device 102, 201, 301. Such interrupt may serve as a programmable event for the one or more applications 108, 214, 314. For example, the programmable event may include a selection of an element or feature of a user interface associated with an application 108, 214, 314. The element or feature may correspond to the x, y, and z coordinates of the object 506. Generation of the unique audible sound, depressing of a button, gesturing with the object, and/or a shaking of the electronic device 102, 201, 301 may be required within a first time period after the object 506 stops moving. In this manner, some of the present methods and apparatus may leverage one or more microphones 204 coupled to the electronic device 102, 201, 301 to enable an element or feature of a user interface, such as a “Select” key, associated with an application 108, 214, 314. The user may use his finger to navigate to the desired user interface element or feature, and instead of touching the display, the user may have 1 second to generate an audible sound, such as a “snap” of his fingers. The one or more microphones 204 would capture this sound, convert the sound to a digital signal via logic, such as an ND converter 209. An algorithm running on a digital signal processor (DSP) or processing unit of the electronic device 102, 201, 301 may interpret the signal as snap or not. The paradigm of a user pointing to a portion of an electronic device screen while being tracked via x, y, z-coordinate object-tracking (e.g., hover-enabling) technology and then snapping (“hover snapping”) to invoke the key-press is a very natural and efficient input method when touch may not be available. False positives due to others in the room snapping away may be reduced or eliminated by requiring the user to snap within 1 second from the time a cursor of the user interface corresponding to the object 506 is moved to the desired user interface element or feature, such as an icon. The user may move the object 506 along one or more of the x, y, and z axes during this selection process as long as the cursor remains over the icon.

In some embodiments, an interrupt in response to a unique audible sound, a user depressing a button, gesturing with the object, and/or a user shaking the electronic device 102, 201, 301 may serve as a programmable event indicating a beginning or end of object movement that may or will be used by an application 108, 214, 314 of the electronic device 102, 201, 301. For example, the electronic device 102, 201, 301 (e.g., a component of the electronic device 102, 201, 301) may generate one or more interrupts including x, y and z coordinates of the object 506 in response to at least one of depressing a button on the electronic device 102, 201, 301, generating a first audible sound, gesturing with the object 506, shaking of the electronic device 102, 201, 301 or stopping movement of the object 506 for a first time period, such as 1 second. However, a larger or smaller time period may be employed. In this manner, although the touch screen 116, 210, 310 may track the object 506 as the object 506 moves above (e.g., whenever the object moves above) the display 108, 206, 306, the electronic device 102, 201, 301 may begin to generate one or more interrupts including the x, y and z coordinates of the tracked object 506 after a user depresses a button on the electronic device 102, 201, 301, generates a first audible sound, gestures with the object (e.g., shaking or wiggling the object in the desired location above the display 102, 201, 301), shakes the electronic device 102, 201, 301 and/or stops movement of the object 506 for a first time period. Therefore, such action may serve to notify the electronic device 102, 201, 301 that subsequent movement of the object 506 may be intended to interact with one or more applications 108, 214, 314 of the electronic device 102, 201, 301.

Similarly, for example, the electronic device 102, 201, 301 may stop generating one or more interrupts including x, y and z coordinates of the tracked object 506 after a user depresses a button on the electronic device 102, 201, 301, generates a second audible sound, gestures with the object (e.g., shaking or wiggling the object in the desired location above the display 102, 201, 301), shakes the electronic device 102, 201, 301 and/or stops moving the object 506 for a second time period, such as one second from when the object is substantially still. Therefore, such action may serve to notify the electronic device 102, 201, 301 that subsequent movement of the object 506 may not be intended to interact with one or more applications 108, 214, 314 of the electronic device 102, 201, 301. In some embodiments, the second audible sound may be the same as the first audible sound. However, the second audible sound may be different than the first audible sound. Further, in some embodiments, the second time period may be the same as the first time period. However, the second time period may be different than the first time period. The gesture used to notify the electronic device 102, 201, 301 that subsequent movement of the object 506 may be intended to interact with one or more applications 108, 214, 314 of the electronic device 102, 201, 301 may be the same as or different than the gesture used to notify the electronic device 102, 201, 301 that subsequent movement of the object 506 may not be intended to interact with one or more applications 108, 214, 314 of the electronic device 102, 201, 301.

In step 408, the tracked z coordinates of the moving object 506 may be employed by an application 108, 214, 314. For example, the tracked z coordinates of the moving object 506 may be employed by a data entry application to insert a character or to update a format of a character entered or to be entered into the data entry application. The tracked z coordinates may be received as interrupts. In one embodiment, an application 108, 214, 314 on the electronic device 102, 201, 301 may associate received x, y, and z coordinates of the object 506 with a selection of a particular character key on a particular virtual keyboard. For example, the application 108, 214, 314 may associate x, y and z coordinates of the object 506 to a selection of “A” on a virtual capital letter keyboard, “b” on a virtual lowercase letter keyboard, “1” on a virtual numeric keyboard, or “&” on a virtual symbol keyboard. The height (e.g., a z coordinate) of the object 506 on or in the air over the display 108, 206, 306 may indicate the virtual keyboard from which a selection is made. Similarly, in some embodiments, an application 108, 214, 314 on the electronic device 102, 201, 301 may associate received x, y and z coordinates of the object 506 with a selection of a particular format key (e.g., bold, italics, underline, strikethrough, subscript, superscript, font, font size, font color) on a virtual format keyboard. An entered character or character to be entered may be formatted based on the format key selection. In some embodiments, the z coordinate of the object 506 controls the format of an entered character or character to be entered. For example, different heights above the display 108, 206, 306 may correspond to different formats (e.g., bold, italics, underline, strikethrough, subscript, superscript, font, font size), respectively. In this manner, a user may select a bold format for an entered character or character to be entered by moving the object 506 to a first height above the display 108, 206, 306. Additionally or alternatively, the user may select italics format for the entered character or character to be entered by moving the object 506 to a second height above the display 108, 206, 306, and so on.

In some embodiments, an application 108, 214, 314 on the electronic device 102, 201, 301 may associate a gesture swiped by the user with the object 506 on and/or in the air over the display 108, 206, 306 with a character. As described above, different heights above the display 108, 206, 306 may correspond to different formats. The height of the object 506 on or in the air over the display 108, 206, 306 before, after or while the gesture is being made may control the format of the character. In this manner, hovering an object over an electronic device display 108, 206, 306 may be employed to change one or more attributes of a written character.

In some embodiments, a user may move an object 506 above the display 108, 206, 306 of the electronic device 102, 201, 301 to verify the user's identity before accessing the electronic device 102, 201, 301. For example, a user may program an authentication application by moving (e.g., performing a gesture with) the object 506 above the display 108, 206, 306. The authentication application may save the x, y and z coordinates associated with such movement as a passcode. Thereafter, when a user repeats the movement, for example when the electronic device 102, 201, 301 is locked, the authentication application on the electronic device 102, 201, 301 receives the x, y and z coordinates corresponding to the object's movements on and/or in the air over the display 108, 206, 306 and compares the coordinates to the predetermined passcode.

Employing a distance an object (e.g., a finger) is away from a display 108, 206, 306 adds a new dimension to the passcode. To wit, basing the passcode on movement of an object 506 in three dimensions significantly increases a number of available passcodes. Consequently, requiring an acceptable passcode from such an increased number of passcodes improves the security of the electronic device 102, 201, 301. For example, a gesture made (e.g., signature performed) on a conventional touch screen may be mapped to a vector <4,2: 3,2: 2,2: 2,3: 2,4: 2,5: 3,5: 3,4: 3,3>. In contrast, a signature performed on and/or in the air above a touch screen in accordance with the present methods and apparatus may be mapped to, for example, a vector such as <4,2,0: 3,2,0: 2,2,0: 2,3,3: 2,4,3: 2,5,2: 3,5,2: 3,4,1: 3,3,0> which records locations in three dimensions above the LCD of the finger while the gesture is made. Once an acceptable passcode is entered by moving the object 506 above the display 108, 206, 306, the user may access other features of the electronic device 102, 201, 301.

Thereafter, step 410 may be performed in which the method 400 of interacting with an electronic device 102, 201, 301 ends. In this manner, a user may interact with one or more applications 108, 214, 314 of an electronic device 102, 201, 301 by moving an object 506 on or in the air over a display 108, 206, 306 of the electronic device 102, 201, 301. Although the methods were described above with reference to a data entry and/or authentication application, the present methods and apparatus may be employed to interface with other applications, for example but not limited to, a photo application or a Web browser. X, y and z coordinates based on movement of the object 506 may be associated by such applications 108, 214, 314 to a programmable event (e.g., such as selection of a button on a user interface or a hyperlink).

In this manner, the present methods and apparatus may provide an electronic device user with more modes of input to interact with the electronic device 102, 201, 301. For example, by employing a z-axis coordinate of the object 506, the present methods and apparatus may enable the user to interact with the electronic device 102, 201, 301 by hovering the object over the electronic device display 108, 206, 306. For example, a user may control an application user interface of the electronic device via hovering the object 506 over the electronic device display 108, 206, 306, without ever having to touch the electronic device display 108, 206, 306. Such methods and apparatus may be critical in industries requiring sanitized hands, such as the medical industry in which users, such as doctors, nurses or other medical personnel who have sanitized their hands may need to interact with an electronic device 102, 201, 301. Allowing a user to interact with an electronic device 102, 201, 301 without ever having to touch the screen may reduce and/or eliminate the risk of such user soiling their finger while interacting with the electronic device 102, 201, 301.

FIG. 5 is a side view 500 of an x, y and z-coordinate object-tracking display 502 of an electronic device 504 used for a data entry application in accordance with an aspect. With reference to FIG. 5, the height of an object 506 above the display 502 (e.g., a top surface 508 of the display 502) determines a virtual keyboard from which a character is to be entered. For example, if the object 506 is moved to height h0, a first keyboard, such as a virtual lowercase keyboard 510, may be displayed from which a character key may be selected based on x and/or y coordinates selected by the user for the object 506. Similarly, height h1 may correspond to a second keyboard, such as a virtual uppercase keyboard 512 from which the user may select a character key by moving the object 506 to desired x and/or y coordinates. As shown, the object 506 is at a height h1 so the virtual uppercase keyboard is displayed.

Height h2 may correspond to another keyboard (e.g., a virtual symbol keyboard 514). Height h3 may correspond to a bold character format. Therefore, a user may select a character from the virtual uppercase keyboard 512 by moving the object 506 above the display 502 to coordinates x, y, and h1. Further, by moving the object 506 such that it has a z coordinate of h3, the format 516 of the selected uppercase character will be updated to bold. Height h4 may correspond to a photo application 518 from which the user may select items from a photo application user interface based on at least one x and/or y position of the object 506 while the object 506 is at height h4.

Although three heights corresponding to respective virtual keyboards, one height corresponding to a character format, and one height corresponding to an application are shown, a larger or smaller number of height mappings may be employed. For example, two additional heights may be employed corresponding to character italics format and character underline format, respectively. Additionally or alternatively, additional heights may be employed to correspond to additional electronic device applications 108, 214, 314, respectively. Although specific heights h0-h4 are referred to above, the present methods and apparatus may employ ranges of heights in addition to or instead of specific heights.

In contrast to computer systems today, the present methods and apparatus implementing hover technology may generate interrupts when an object is in the air over or pressing a touch screen whereby a window manager reports that event to the appropriate application. The triggered event may include a distance parameter that is forwarded to the application for use.

In this manner, the present methods and apparatus may allow electronic device users who often use a stylus or their index finger, for example, to interact with (e.g., write on) their electronic device touch screen 116, 210, 310 to enter a character with minimal effort and change with minimal effort a capitalization, font size, bolding, underling, among other things, of the character possibly by hovering the stylus or index finger over the display 108, 206, 306. Therefore, the present methods and apparatus may allow “hover data entry” and/or “hover data formatting”. The present methods and apparatus may employ a distance above the writing surface as means to program the attributes of a character being written. For example, the user may use his index finger to write a letter on a phone's display, and raise his finger slightly to capitalize the letter, and raise it even further during the gesture to make the character bold. The same gesture may be used to create a capital letter, its lowercase counterpart, or some stylized version (e.g., bold or underline) of the letter depending on the level above the display surface at which the gesture was made. In some embodiments, the present methods and apparatus may allow an electronic device user to verify their identity before logging into their electronic device 102, 201, 301 by entering an alphanumeric passcode using hover data entry.

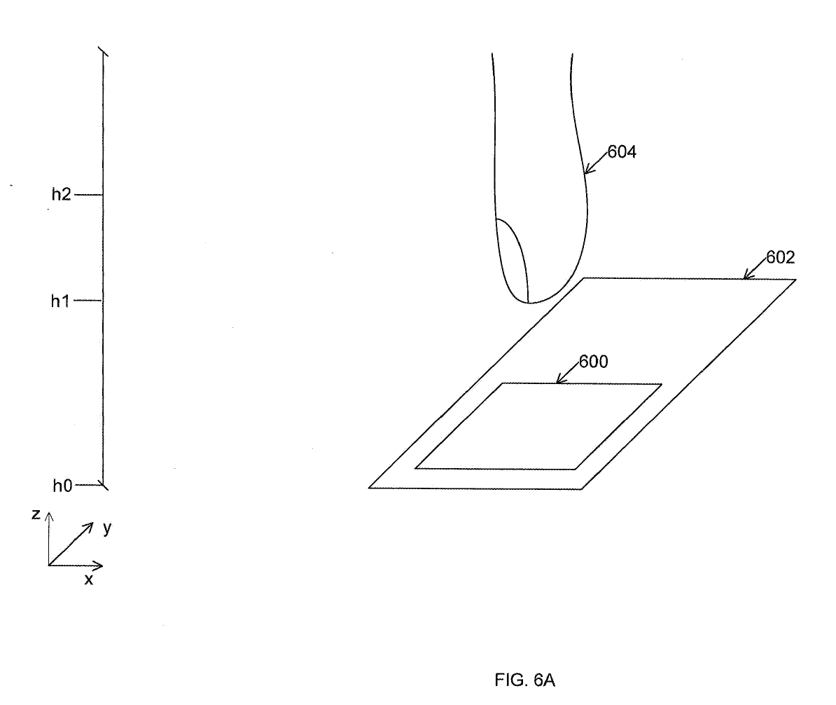

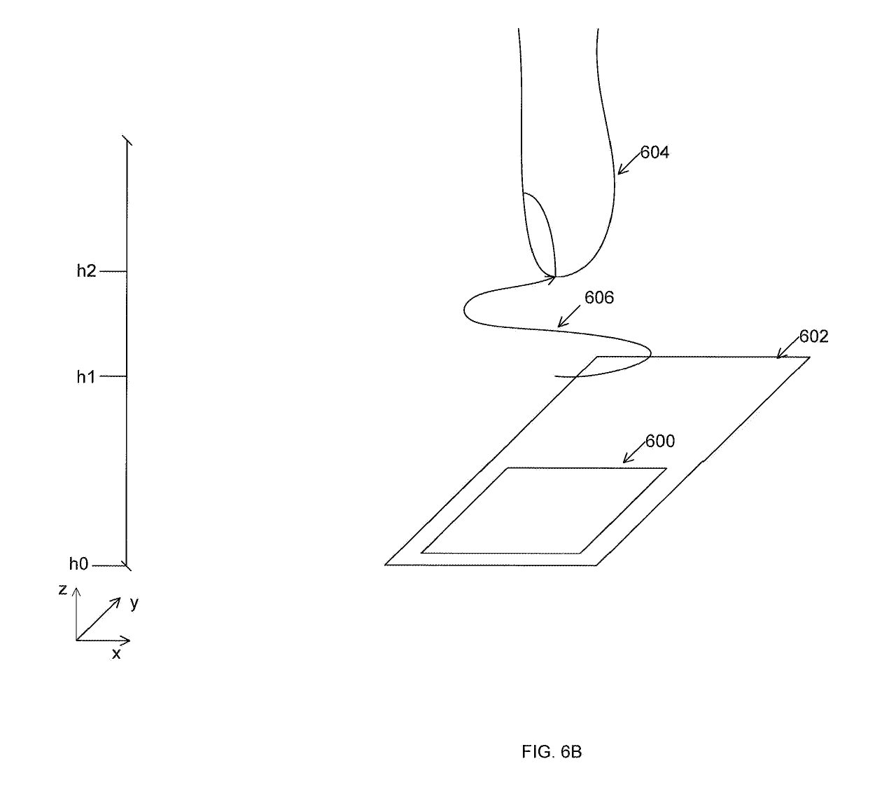

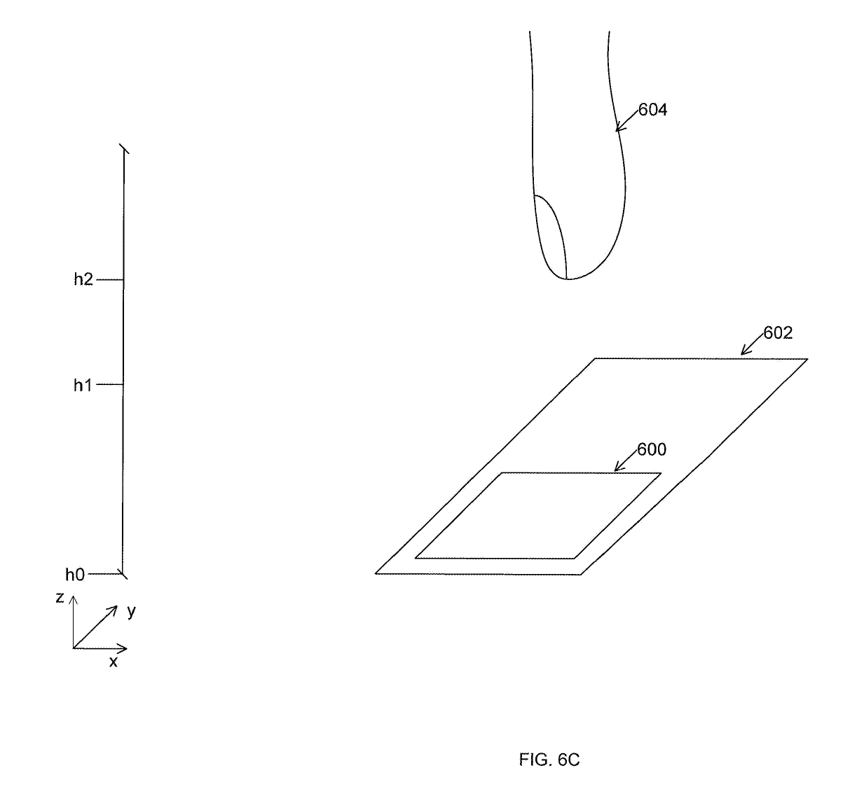

FIG. 6A-C illustrate a display 600 of an electronic device 602 used for an authentication application in accordance with an aspect. With reference to FIGS. 6A-C, in FIG. 6A, a user starts an authentication process by positioning the object 604 such that the z coordinate is h1. In FIG. 6B, the user performs a gesture 606 by moving the object 604 in the x, y and/or z directions. As shown in FIG. 6C, the user completes the gesture and stops moving the object 604. The object 604 is now positioned such that the z coordinate is h2. The authentication application may receive the x, y and z coordinates of the tracked object movement, and compare such coordinates to a predetermined passcode. Based on the comparison, the authentication application may allow the user to access the electronic device 602. For example, if the gesture 606 matches or is substantially similar to the predetermined passcode, the authentication application may allow the user to access the electronic device 602. Alternatively, if the gesture 606 does not match or is not substantially similar to the predetermined passcode, the authentication application may deny the user access to the electronic device 602.

In this manner, the present methods and apparatus may allow an electronic device user to verify their identity before logging into their electronic device 102, 201, 301 by drawing a figure above the electronic device display 102, 201, 301. Therefore, the present methods and apparatus may implement hover technology for security by allowing user verification by “hover signing”.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The foregoing description discloses only the exemplary embodiments of the invention. Modifications of the above-disclosed embodiments of the present invention which fall within the scope of the invention will be readily apparent to those of ordinary skill in the art. For instance, in some embodiments, heights of the objects 506, 604 above an electronic device display 108, 206, 306 may correspond to respective user interfaces of an application 108, 214, 314.

Accordingly, while the present invention has been disclosed in connection with exemplary embodiments thereof, it should be understood that other embodiments may fall within the spirit and scope of the invention as defined by the following claims.

The invention claimed is:

1. A method of interacting with an electronic device, comprising:
tracking the x, y and z coordinates of an object moving above a display of the electronic device, wherein a top surface of the display is substantially aligned with an xy-plane;
generating an interrupt including the x, y and z coordinates; and
employing the tracked z coordinates of the moving object by an application of the electronic device.

2. The method of claim 1 wherein:
the application is a data entry or authentication application; and
employing the tracked z coordinates of the moving object by the application of the electronic device includes inserting a character, updating a format of an entered character or updating the format of a character to be entered into the data entry application based on the tracked z coordinates.

3. The method of claim 2 wherein the format is selected from the group consisting of bold, italics, underline, strikethrough, subscript, superscript, font, font size, and font color.

4. The method of claim 1 wherein:
the application is a data entry or authentication application; and
employing the tracked z coordinates of the moving object by the data entry or authentication application of the electronic device includes verifying an identity of a user of the electronic device based on the tracked z coordinates before unlocking the electronic device.

5. The method of claim 1 wherein the object is a finger or stylus.

6. The method of claim 1 wherein tracking the x, y and z coordinates of an object moving above a display of the electronic device includes employing a capacitive or resistive touch screen to track the x, y and z coordinates.

7. The method of claim 1 wherein tracking the x, y and z coordinates of an object moving above a display of the electronic device includes employing at least one transducer and at least one receiver to track the x, y and z coordinates.

8. The method of claim 1 wherein tracking the x, y and z coordinates of an object moving above a display of the electronic device includes employing at least one light source and at least one light receiver to track the x, y and z coordinates.

9. The method of claim 1 wherein the object moving above the display does not touch the display.

10. The method of claim 1 further comprising employing an audible sound, button depress, gesture with the object or shaking of the electronic device as a programmable event by the application of the electronic device.

11. The method of claim 10 wherein employing the audible sound, button depress, gesture with the object or shaking of the electronic device as a programmable event by the application of the electronic device includes when the object stops moving, within a first time period, employing the audible sound, button depress, gesture with the object or shaking of the electronic device as the programmable event by the application of the electronic device.

12. The method of claim 1 wherein the object moving above the display touches the display during one portion of the movement and moves in the air over the display during another portion of the movement.

13. The method of claim 1 wherein generating an interrupt including the x, y and z coordinates includes generating an interrupt including the x, y and z coordinates in response to at least one of depressing a button on the electronic device, generating a first audible sound, gesturing with the object, shaking of the electronic device or stopping movement of the object for a first time period.

14. The method of claim 13 further comprising stopping generation of the interrupt including the x, y and z coordinates in response to at least one of releasing a button on the electronic device, generating a second audible sound, gesturing with the object, shaking of the electronic device or stopping movement of the object for a second time period.

15. An electronic device, comprising:
a circuit configured to track the x, y and z coordinates of an object moving above a display of the electronic device, wherein a top surface of the display is substantially aligned with an xy-plane;
a controller coupled to the circuit and configured to generate an interrupt including the x, y and z coordinates; and
a processor coupled to the controller and configured to employ the tracked z coordinates of the moving object for an application executed by the processor.

16. The electronic device of claim 15 wherein:
the application is a data entry or authentication application; and
the processor is further configured to insert a character, update a format of an entered character or update a format of a character to be entered into the application based on the tracked z coordinates.

17. The electronic device of claim 16 wherein the format is selected from the group consisting of bold, italics, underline, strikethrough, subscript, superscript, font, font size, and font color.

18. The electronic device of claim 15 wherein:
the application is a data entry or authentication application; and
the processor is further configured to verify an identity of a user of the electronic device based on the tracked z coordinates before unlocking the electronic device.

19. The electronic device of claim 15 wherein the object is a finger or stylus.

20. The electronic device of claim 15 wherein the circuit includes a capacitive or resistive touch screen.

21. The electronic device of claim 15 wherein the circuit includes at least one transducer and at least one receiver.

22. The electronic device of claim 15 wherein the circuit includes at least one light source and at least one light receiver.

23. The electronic device of claim 15 wherein the object moving above the display does not touch the display.

24. The electronic device of claim 15 wherein the processor is further configured to employ an audible sound, button depress, gesture with the object or shaking of the electronic device as a programmable event for the application.

25. The electronic device of claim 24 wherein the processor is further configured to when the object stops moving, within a first time period, employ the an audible sound, button depress, gesture with the object or shaking of the electronic device as the programmable event for the application.

26. The electronic device of claim 15 wherein the object moving above the display touches the display during one portion of the movement and moves in the air over the display during another portion of the movement.

27. The electronic device of claim 15 wherein the controller is further configured to generate an interrupt including the x, y and z coordinates in response to at least one of depressing a button on the electronic device, generating a first audible sound, gesturing with the object, shaking of the electronic device or stopping movement of the object for a first time period.

28. The electronic device of claim 27 wherein the controller is further configured to stop generation of an interrupt including the x, y and z coordinates in response to at least one of releasing a button on the electronic device, generating a second audible sound, gesturing with the object, shaking of the electronic device or stopping movement of the object for a second time period.

29. An electronic device, comprising:
means for tracking the x, y and z coordinates of an object moving above a display of the electronic device, wherein a top surface of the display is substantially aligned with an xy-plane;
means for generating an interrupt including the x, y and z coordinates; and
means for employing the tracked z coordinates of the moving object by an application of the electronic device.

30. The electronic device of claim 29:
wherein the application is a data entry or authentication application; and
further comprising means for inserting a character, updating a format of an entered character or updating a format of a character to be entered into the data entry or authentication application based on the tracked z coordinates.

31. The electronic device of claim 30 wherein the format is selected from the group consisting of bold, italics, underline, strikethrough, subscript, superscript, font, font size, and font color.

32. The electronic device of claim 29:
wherein the application is a data entry or authentication application; and
further comprising means for verifying an identity of a user of the electronic device based on the tracked z coordinates before unlocking the electronic device.

33. The electronic device of claim 29 wherein the object is a finger or stylus.

34. The electronic device of claim 29 wherein the object moving above the display does not touch the display.

35. The electronic device of claim 29 further comprising means for employing an audible sound, button depress, gesture with the object or shaking of the electronic device as a programmable event by the data entry or authentication application of the electronic device.

36. The electronic device of claim 35 further comprising when the object stops moving, within a first time period, means for employing audible sound, button depress, gesture with the object or shaking of the electronic device as the programmable event by the data entry or authentication application of the electronic device.

37. The electronic device of claim 29 wherein the object moving above the display touches the display during one portion of the movement and moves in the air over the display during another portion of the movement.

38. The electronic device of claim 29 further comprising means for generating an interrupt including the x, y and z coordinates in response to at least one of depressing a button on the electronic device, gesturing with the object, generating a first audible sound, shaking of the electronic device or stopping movement of the object for a first time period.

39. The electronic device of claim 38 further comprising means for stopping generation of the interrupt including the x, y and z coordinates in response to at least one of a releasing a button, generating a second audible sound, gesturing with the object, shaking of the electronic device or stopping movement of the object for a second time period.

40. A non-transitory storage media comprising program instructions which are computer-executable to implement interacting with an electronic device and which when executed perform the steps of:
tracking the x, y and z coordinates of an object moving above a display of the electronic device, wherein a top surface of the display is substantially aligned with an xy-plane;
generating an interrupt including the x, y and z coordinates; and
employing the tracked z coordinates of the moving object by an application of the electronic device.

41. The non-transitory storage media of claim 40 wherein:
the application is a data entry or authentication application; and
employing the tracked z coordinates of the moving object by the data entry or authentication application of the electronic device includes inserting a character, updating a format of an entered character or updating a format of a character to be entered into the data entry application based on the tracked z coordinates.

42. The non-transitory storage media of claim 41 wherein the format is selected from the group consisting of bold, italics, underline, strikethrough, subscript, superscript, font, font size, and font color.

43. The non-transitory storage media of claim 40 wherein:
the application is a data entry or authentication application; and
employing the tracked z coordinates of the moving object by the data entry or authentication application of the electronic device includes verifying an identity of a user of the electronic device based on the tracked z coordinates before unlocking the electronic device.

44. The non-transitory storage media of claim 40 wherein the object is a finger or stylus.

45. The non-transitory storage media of claim 40 wherein tracking the x, y and z coordinates of an object moving above a display of the electronic device includes employing a capacitive or resistive touch screen to track the x, y and z coordinates.

46. The non-transitory storage media of claim 40 wherein tracking the x, y and z coordinates of an object moving above a display of the electronic device includes employing at least one transducer and at least one receiver to track the x, y and z coordinates.

47. The non-transitory storage media of claim 40 wherein tracking the x, y and z coordinates of an object moving above a display of the electronic device includes employing at least one light source and at least one light receiver to track the x, y and z coordinates.

48. The non-transitory storage media of claim 40 wherein the object moving above the display does not touch the display.

49. The non-transitory storage media of claim 40 wherein the program instructions further comprise the step of employing an audible sound, button depress, gesture with the object or shaking of the electronic device as a programmable event by the data entry or authentication application of the electronic device.

50. The non-transitory storage media of claim 49 wherein employing the audible sound, button depress, gesture with the object or shaking of the electronic device as a programmable event by the data entry or authentication application of the electronic device includes when the object stops moving, within a first time period, employing the audible sound, button depress, gesture with the object or shaking of the electronic device as the programmable event by the data entry or authentication application of the electronic device.

51. The non-transitory storage media of claim 40 wherein the object moving above the display touches the display during one portion of the movement and moves in the air over the display during another portion of the movement.

52. The non-transitory storage media of claim 40 wherein generating an interrupt including the x, y and z coordinates includes generating an interrupt including the x, y and z coordinates in response to at least one of depressing a button on the electronic device, gesturing with the object, generating a first audible sound, shaking of the electronic device or stopping movement of the object for a first time period.

53. The non-transitory storage media of claim 52 wherein the program instructions further perform the step of stopping generation of the interrupt including the x, y and z coordinates in response to at least one of releasing a button, generating a second audible sound, gesturing with the object, shaking of the electronic device or stopping movement of the object for a second predetermined time period.
